(19) United States
(12) Patent Application Publication
(10) Pub. No.: US 2014/0263406 A1
(43) Pub. Date: Sep. 18, 2014

(54) Beverage Dispenser with Integrated Carbonator and a Potable Water/Ice Slurry Refrigeration System

(71) Applicant: The Coca-Cola Company, Atlanta, GA (US)

(72) Inventors: Charles Bradley Green, Lawrenceville, GA (US); Arthur G. Rudick, Atlanta, GA (US); Daniel S. Quartarone, Stone Mountain, GA (US); Ian Stewart Fitzpatrick, Elwood (AU); Joanne Fleming, Del Mar, CA (US); David Berardelli, San Diego, CA (US)

(73) Assignee: The Coca-Cola Company, Atlanta, GA (US)

(21) Appl. No.: 14/200,073

(22) Filed: Mar. 7, 2014

Related U.S. Application Data
(60) Provisional application No. 61/781,132, filed on Mar. 14, 2013.

(51) Int. Cl. B67D 1/00

(52) U.S. Cl. CPC B67D 1/0058; B67D 1/004
USPC 222/1; 222/129.1; 261/152; 62/332

(57) ABSTRACT

The present application provides a beverage dispenser for mixing a flow of concentrate, a flow of water, and a flow of gas. The beverage dispenser may include a carbonator with a water input in communication with the flow of water, a gas input in communication with the flow of gas, a carbonated water output, and a chilling reservoir in communication with the flow of water, and a dispensing nozzle in communication with the flow of concentrate and a flow of carbonated water from the carbonated water output of the carbonator.

### RELATED APPLICATIONS

The present application claims priority from provisional application Ser. No. 61/781,132, filed on Mar. 14, 2013. Ser. No. 61/781,132 is incorporated herein by reference in full.

### TECHNICAL FIELD

The present application and the resultant patent relate generally to beverage dispensers and more particularly relate to beverage dispensers having an ice cooled integrated carbonator for home use or use in other types of lower volume locations and/or a potable water/ice slurry refrigeration system.

### BACKGROUND OF THE INVENTION

Beverage dispensers for soft drinks, sports drinks, waters, and the like, generally include a device for producing carbonated water. A common device for producing and storing carbonated water is a carbonator. Generally described, most carbonators include a pressurized tank, a plain water inlet, a carbon dioxide gas inlet, and a carbonated water outlet. Once the plain water and the carbon dioxide gas mix within the tank, the carbonated water generally remains in the tank until needed for a beverage. The carbonator may be chilled or the carbonated water may be chilled at another location prior to a dispense.

Most commercially available beverage dispensers are generally designed for large volume commercial outlets such as restaurants and other types of retail outlets. The beverage dispensers thus must accommodate large volumes of beverages within a small amount of time. Given such, beverage dispenser design has focused generally on maximizing cooling and dispensing speeds. Such beverage dispensers thus may be relatively large, expensive, and generally not intended to be portable.

There is thus a desire for a lower volume beverage dispenser for carbonated beverages. Such a beverage dispenser, however, should provide the same quality carbonated beverages as produced by conventional beverage dispensers while being reasonable in terms of size, cost, variety, and ease of operation in terms of dispensing, refilling, maintenance, and the like.

### SUMMARY OF THE INVENTION

The present application and the resultant patent thus provide a beverage dispenser for mixing a flow of concentrate, a flow of water, and a flow of gas. The beverage dispenser may include a carbonator with a water input in communication with the flow of water, a gas input in communication with the flow of gas, a carbonated water output, and a chilling reservoir in communication with the flow of water, and a dispensing nozzle in communication with the flow of concentrate and a flow of carbonated water from the carbonated water output of the carbonator.

The present application and the resultant patent further provide a method of operating a beverage dispenser. The method may include the steps of filling a water/ice reservoir with water and ice, circulating a first flow of water about a carbonator to chill the carbonator, flowing a second flow of water into the carbonator, flowing a flow of gas into the carbonator to produce a flow of carbonated water, flowing the flow of carbonated water to a dispensing nozzle, and flowing a flow of concentrate through a concentrate coil in the carbonator and to the dispensing nozzle.

The present application and the resultant patent further provide carbonator for use with a beverage dispenser for mixing a flow of concentrate, a flow of water, and a flow of gas. The carbonator may include a water input in communication with the flow of water, a gas input in communication with the flow of gas, a carbonated water output, a chilling reservoir in communication with the flow of water, and a concentrate coil in communication with the flow of concentrate.

The present application and the resultant patent further provides for a potable water/ice slurry refrigeration system. The potable water/ice slurry refrigeration system may include a water/ice slurry tank, a heat exchanger positioned about the water/ice slurry tank, an ice bin positioned about the water/ice slurry tank, and a grate positioned between the water/ice slurry tank and the ice bin.

The present application and the resultant patent further provide a method of chilling a number of fluids in a beverage dispenser. The method may include the steps of positioning an amount of ice in an ice bin, allowing the ice to melt into a water/ice slurry tank, flowing water into the water/ice slurry tank, flowing an ingredient through a heat exchanger positioned about the water/ice slurry tank, flowing water from the water/ice slurry tank to a nozzle, and flowing the ingredient from the heat exchanger to the nozzle to create a beverage.

These and other features and improvements of the present application and the resultant patent will become apparent to those of ordinary skill in the art upon review of the following detailed description when taken in conjunction with the several drawings and the appended claims.

### BRIEF DESCRIPTION OF THE DRAWINGS

FIG. 1 is a schematic view of a beverage dispenser as may be described herein.

FIG. 2 is a perspective view of a carbonator that may be used with the beverage dispenser of FIG. 1.

FIG. 3 is a top plan view of the carbonator of FIG. 2.

FIG. 4 is a side cross-sectional view of the carbonator of FIG. 2 showing the concentrate coils therein.

FIG. 5 is a schematic diagram of a potable water/ice slurry refrigeration system as may be described herein.

FIG. 6 is a schematic diagram of an alternative embodiment of a potable water/ice slurry refrigeration system as may be described herein.

FIG. 7 is a schematic diagram of an alternative embodiment of a potable water/ice slurry refrigeration system as may be described herein.

FIG. 8 is a schematic diagram of an alternative embodiment of a potable water/ice slurry refrigeration system as may be described herein.

FIG. 9 is a schematic diagram of an alternative embodiment of a potable water/ice slurry refrigeration system as may be described herein.

FIG. 10 is a schematic diagram of an alternative embodiment of a potable water/ice slurry refrigeration system as may be described herein.

FIG. 11 is a schematic diagram of grate that may be used with the potable water/ice slurry refrigeration systems described above.

### DETAILED DESCRIPTION

Referring now to the drawings, in which like numerals refer to like elements throughout the several views, FIG. 1 shows a schematic diagram of an example of a beverage dispenser 100 as may be described herein. The components of the beverage dispenser 100 may be positioned within a housing 110. The housing 110 may be made out of thermoplastics, metals, combinations thereof, and the like. The housing 110 may have any size, shape, or configuration. The beverage dispenser 100 may include a controller 120 for overall operations and communications. The controller 120 may be any type of programmable processing device and the like. The controller 120 may be positioned within the housing 110 or the controller 120 may be external thereof. Multiple controllers 120 also may be used.

A consumer may select a beverage via a consumer input device 130 positioned on the housing 110. In this example, the consumer input device 130 may be a conventional touchscreen 140 or a similar type of device. Alternatively, mechanical devices, electro-mechanical device, audio devices, optical devices, and the like also may be used herein. In this example, the touchscreen 140 may have a number of icons representing a number of beverages and a number of flavors. A first beverage icon 150 may represent a first beverage 160, a second beverage icon 170 may represent a second beverage 180, a third beverage icon 190 may represent a third beverage 200, and a fourth beverage icon 210 may represent a fourth beverage 220. Any number of beverage icons and beverages may be used herein. The touchscreen 140 also may include a number of flavor icons representing a number of flavors. A first flavor icon 230 may represent a first flavor 240, a second flavor icon 250 may represent a second flavor 260, a third flavor icon 270 may represent a third flavor 280, and a fourth flavor icon 290 may represent a fourth flavor 300. Any number of flavor icons and flavors may be used herein.

The touchscreen 140 also may include a pour icon 310. Touching the pour icon 310 may initiate the dispense of a beverage. Alternatively, the beverage dispenser 100 may include a separate pour button 320 positioned elsewhere on the housing 110. The pour button 320 may be an electromechanical device, a further touchscreen, or other type of input device. Pushing the pour button 320 also may initiate the dispense of a beverage. Pressing the pour button 320 may initiate a dispense of a predetermined volume (batch) or the dispense may continue for as long as the pour button 320 is held (continuous). Other types of icons and displays may be available on the touchscreen 140. For example, information concerning price, nutrition, volume, and the like may be available. Any type of information may be displayed herein.

The beverage dispenser 100 also may include a number of beverage cartridges positioned within the housing 110. The beverage cartridges may contain beverage concentrates that relate to the beverages described above. In this example, a first beverage cartridge 330 may include a first beverage concentrate 340, a second beverage cartridge 350 may include a second beverage concentrate 360, a third beverage cartridge 370 may include a third beverage concentrate 380, and a fourth beverage cartridge 390 may include a fourth beverage concentrate 400. Any number of cartridges and beverage concentrates may be used herein. Each of the beverage cartridges may be in communication with a concentrate pump 410. The concentrate pumps 410 may be of conventional design and may be a positive displacement pump and the like. Likewise, the beverage dispenser 100 also may include a number of flavor cartridges with the flavors therein. A first flavor cartridge 420 may have the first flavor 240 therein, a second flavor cartridge 430 may have the second flavor 260 therein, a third flavor cartridge 440 may have the third flavor 280 therein, and a fourth flavor cartridge 450 may have the fourth flavor 300 therein. Any number of flavor cartridges may be used herein. Each of the flavor cartridges may be in communication with a flavor pump 460. The flavor pumps 460 may be of conventional design and may be a positive displacement pump and the like.

The beverage concentrates and flavors may be convention single brand concentrates or flavor concentrates. A number of beverage concentrates and flavors may be available to produce a number of standard core beverages and flavor modifiers. The beverage concentrates and flavors may have varying levels of concentration. Alternatively, the beverage concentrates and/or flavors may be separated in macro-ingredients and micro-ingredients. Generally described, the macro-ingredients may have reconstitution ratios in the range of about 3:1 to about 6:1. The viscosities of the macro-ingredients typically range from about 100 centipoise or higher. Macro-ingredients may include sugar syrup, HFCS (High Fructose Corn Syrup), juice concentrates, and similar types of fluids.

The micro-ingredients may have a reconstitution ratio ranging from about ten to one (10:1), twenty to one (20:1), thirty to one (30:1), or higher. Specifically, many micro-ingredients may be in the range of fifty to one (50:1) to three hundred to one (300:1). The viscosities of the micro-ingredients typically range from about 1 to about 100 centipoise or so. Examples of micro-ingredients include natural and artificial flavors; flavor additives; natural and artificial colors; artificial sweeteners (high potency or otherwise); additives for controlling tartness, e.g., citric acid, potassium citrate; functional additives such as vitamins, minerals, herbal extracts; nutraceuticals; and over-the-counter (or otherwise) medicines such as acetaminophen and similar types of materials. The acid and non-acid components of the non-sweetened concentrate also may be separated and stored individually. The micro-ingredients may be liquid, powder (solid), or gaseous form and/or combinations thereof.

The beverage dispenser 100 also may include a carbon dioxide source 470 positioned within the housing 110. The carbon dioxide source 470 may be a carbon dioxide tank 480 and the like. The carbon dioxide tank 480 may have any size, shape, or configuration. Multiple carbon dioxide tanks 480 may be used. An external carbon dioxide source also may be used. A tank sensor 490 may be used to detect the presence of the carbon dioxide tank 480 within the housing 110. The tank sensor 490 may be of conventional design and may be in communication with the controller 120. A pressure regulator 500 may be used with or downstream of the carbon dioxide tank 480. The pressure regulator 500 may be of conventional design.

The beverage dispenser 100 may include a removable water/ice reservoir 510. The water/ice reservoir 510 may have any size, shape, or configuration. The water/ice reservoir 510 is intended for use with a volume of water 520 and/or ice 530. The water/ice reservoir 510 may be in communication with a source of water and/or ice and/or the water/ice reservoir 510 may be refilled manually. The water/ice reservoir 510 may have a level sensor 540, a temperature sensor 550, and the like. The sensors 540, 550 may be of conventional design and may be in communication with the controller 120. A fill pump 560 and a recirculation pump 570 may be in communication with the water/ice reservoir 510 as will be described in more detail below. The pumps 560, 570 may be of conventional design.

The beverage dispenser 100 also may include a dispensing nozzle 580. The dispensing nozzle 580 may mix the streams of beverage concentrate 340, 360, 380, 400; flavors 240, 260, 280, 300; and water 520 so as to create the beverages 160, 180, 200, 220. The dispensing nozzle 580 may be of conventional design. The dispensing nozzle 580 may mix the fluid streams via a target or via air mixing and the like. Other components and other configurations may be used herein.

The beverage dispenser 100 also may include a carbonator 600. The carbonator 600 may be positioned within the housing 110. The carbonator 600 may have any size, shape, or configuration. An example of the carbonator as is described herein is shown in FIGS. 1-4.

The carbonator 600 may include an outer jacket 610. The outer jacket 610 may be partially cylindrical in shape and may have any length or diameter. The outer jacket 610 may be made from an outer layer of an acrylic or similar types of materials and an inner layer of an insulating material with good thermal characteristics. Other types of materials may be used herein.

The carbonator 600 may include a water jacket 620. The water jacket 620 may be positioned within the outer jacket 610 and may define a chilling reservoir 630 therebetween. The water jacket 620 may have any length or diameter. The water jacket 620 may be made out of metals and other types of materials with good thermal characteristics. Likewise, the chilling reservoir 630 may have any length, diameter, or volume. The water jacket 620 may be a pressurized tank for mixing the water 520 and the carbon dioxide 485 therein. The chilling reservoir 630 may surround the water jacket 620. A water input port 640 and a water output port 650 may extend through the outer jacket 610 to the chilling reservoir 630. The chilling reservoir 630 may be in communication with the water/ice reservoir 510 via a recirculation loop 660. The recirculation loop 660 extends from the water/ice reservoir 510 to the water input port 640 via the recirculation pump 570 and then back to the water/ice reservoir 510 via the water output port 650. The recirculation loop 660 thus keeps the water 520 in the chilling reservoir 630 cold so as to chill the water jacket 620 and the internal components thereof. Other components and other configurations may be used herein.

The carbonator 600 may include a heat sink 670 positioned about the water jacket 620. In this example, the heat sink 670 may be a finned heat exchanger 680. Other types of heat exchangers may be used herein. The heat sink 670 may have any size, shape, or configuration. Positioned between the water jacket 620 and the heat sink 670 may be a thermo-electric chilling device 690. The thermo-electric chilling device 690 may be a Peltier device 700 and the like. As is known, a Peltier device creates a heat flux at a junction between two different types of materials via an electric charge. The Peltier device has the advantages of being small and largely silent. The Peltier device 700 thus transfers heat from the water jacket 620 to the heat sink 670 so as to cool the water jacket 620 and the internal components thereof. Other types of cooling devices also may be used herein. A fan 710 or other type of air movement device may be positioned about the heat sink 670. Other components and other configurations may be used herein.

The outer jacket 610 and the water jacket 620 of the carbonator 600 may be enclosed by a two-piece cap 720. The two-piece cap 720 may include a lower cap 730. The lower cap 730 may have any size, shape, or configuration. The lower cap 730 may have a number of mounting flanges 740 extending therefrom. The lower cap 730 may be made from any type of substantially rigid thermoplastic materials and the like. The two-piece cap 720 also may include an upper cap 750. The upper cap 750 may have a number of solenoid mounts 760 and passageways 770 formed therein. The upper cap 750 may have any size, shape, or configuration. The upper cap 750 also may be made from any type of substantially rigid thermoplastic material and the like.

The carbonator 600 may include a number of concentrate coils positioned within the water jacket 620 to chill the beverage concentrate therein. The concentrate coils may have any size, shape, or configuration. A first concentrate coil 760 may be in communication with the first beverage cartridge 330 to chill the first beverage concentrate 340, a second concentrate coil 790 may be in communication with the second concentrate cartridge 350 to chill the second beverage concentrate 360, a third concentrate coil 800 may be in communication with the third concentrate cartridge 370 to chill the third beverage concentrate 380, and a fourth concentrate coil 810 may be in communication with the fourth concentrate cartridge 390 to chill the fourth beverage concentrate 400. Any number of concentrate coils may be used herein. The concentrate coils may extend through the two-piece cap 720 or elsewhere in the carbonator 600 via a number of concentrate ports 820 extending through. The beverage concentrates 340, 360, 380, 400 thus may be pumped via the concentrate pumps 410 into the carbonator 600 so as to be chilled within the concentrate coils 780, 790, 800, 810, and then onto the dispensing nozzle 580. Other components and other configurations also may be used herein.

The carbonator 600 may be in communication with the flow of carbon dioxide 485 from the carbon dioxide source 470 via a carbon dioxide solenoid 830. The carbon dioxide solenoid 830 may be of conventional design. Alternatively, any type of flow control device may be used herein. The carbon dioxide solenoid 830 may be mounted on the two-piece cap 720. The carbon dioxide solenoid 830 may be in communication with a stinger tube 840 via a check valve 850. The stinger tube 840 may extend into the water jacket 620 towards a bottom end thereof and may be positioned within the concentrate coils 780, 790, 800, 810. A pressure relief valve 860 may be positioned on the two-piece cap 720 adjacent to the carbon dioxide solenoid 830. The pressure relief valve 860 may be of conventional design. Other components and other configurations may be used herein.

The carbonator 600 also may include a water inlet 870. The water inlet 870 may be in communication with the flow water 520 from the water/ice reservoir 510 via the fill pump 560 or otherwise. The water inlet 870 may extend through the two-piece cap 720 into the water jacket 620 via a water check valve 880. The water check valve 880 may be of conventional design. The water inlet 870 may lead to a water nozzle 890 so as to add velocity to the flow of water 520 for increase agitation therein. The water nozzle 890 may have an area of narrowing diameter and the like. Other components and other configurations may be used herein.

The carbonator 600 also may include an agitation bypass system 900. The agitation bypass system 900 may include an agitation bypass solenoid 910. The agitation bypass solenoid 910 may be of conventional design. Alternatively, any type of flow control device may be used herein. The agitation bypass solenoid 910 may be positioned about the two-piece cap 720 and may be in communication with a bypass dip tube 920 extending into the water jacket 620. Water 520 from within the water jacket 620 may be forwarded into a recirculation loop 930. The recirculation loop 930 extends from the bypass dip tube 920, to the agitation bypass solenoid 910, to the recirculation pump 570, and back through the water inlet 870. The recirculation loop 930 may serve to provide agitation to the water stream 520 so as to increase the level of carbonation absorption therein. The agitation bypass solenoid 910 also may assist in self-purging the carbonator 600 upon initial use. A carbon dioxide vent muffler 940 may be positioned about the recirculation loop 930. The carbon dioxide vent muffler 940 may be of conventional design. Other components and other configurations may be used herein.

The carbonator 600 also may include a carbonated water outlet system 950. The carbonated water outlet system 950 may include a carbonated water solenoid 960. The carbonated water solenoid 960 may be of conventional design. Alternatively, any type of flow control device may be used herein. The carbonated water solenoid 960 may be positioned about the two-piece cap 720. The carbonated water solenoid 960 may be in communication with a flow of carbonated water 970 from within the water jacket 620 via a water dip tube 980. The water dip tube 980 extends into the water jacket 620 near a bottom end thereof. An output check valve 990 may be used. The output check valve 990 may be of conventional design. The carbonated water output system 950 may be in communication with the dispensing nozzle 580 via a carbonated water line 1000. Other components and other configurations may be used herein.

The carbonator 600 also may include a temperature sensor 1010, a level sensor 1020, and other types of sensors. A flow meter 1030 may be used on the carbonated water line 1000 and elsewhere. The sensors 1010, 1020 and the flow meter 1030 may be of conventional design. The sensors 1010, 1020 and the flow meter 1030 may be in communication with the controller 1020. Other components and other configurations may be used herein.

In use, the beverage cartridges 330, 350, 370, 390 and the flavor cartridges 420, 430, 440, 450 may be positioned within the housing 110. The water/ice reservoir 510 may be filled with water 520 and/or ice 530 and positioned within the housing 110. Likewise, the carbon dioxide source 470 may be positioned within the housing 110. The fill pump 560 may fill the water jacket 620 of the carbonator 600 with water while the recirculation pump 570 starts to circulate water 520 through the chilling reservoir 630 via the recirculation loop 660. The agitation bypass system 900 may be used so as to increase the carbonation level of the carbonated water 970 within the water jacket 620. Likewise, the carbonator 600 and the carbonated water 970 therein may be further chilled via the thermoelectric cooler 690.

Once the carbonated water 970 within the water jacket 620 of the carbonator 600 has reached a predetermined temperature, the beverage dispenser 100 may allow a consumer to select a beverage via the touchscreen 140 of the consumer input device 130. The consumer may select one of the beverages 160, 180, 200, 220 via one of the beverage icons 160, 180, 200, 220 and/or one of the flavors 240, 260, 280, 300 via the flavor icons 230, 250, 270, 290. Once the appropriate beverage is selected, the consumer may press the pour icon 310 or the pour icon 320. The controller 120 then may activate the appropriate concentrate pump 410 so as to pump the beverage appropriate concentrate 340, 360, 380, 400 from the appropriate concentrate cartridge 330, 350, 370, 390 into the appropriate concentrate coil 780, 790, 800, 810 so as to chill the concentrate therein. Likewise, the controller 120 may activate the carbonated water solenoid of the carbonated water outlet system 950 so as to forward a flow of carbonated water 970 at the appropriate flow rate. The beverage concentrate and the carbonated water then may mix within or downstream of the dispensing nozzle 580. More than one concentrate 340, 360, 380, 400 and/or more than one flavor 240, 260, 280, 300 may be used herein to create a single beverage. The fill pump 560 may refill the water jacket 620 with water 520 from the water/ice reservoir 510 when appropriate so as to ensure a predetermined volume of carbonated water 970 therein. Other components and other configurations may be used herein.

The beverage dispenser 100 described herein thus provides quality carbonated beverages and the like without the use of bulking and noisy refrigeration systems. Rather, cooling is provided via the water/ice reservoir 510 and the thermoelectric cooler 690. The consumer merely needs to keep the water/ice reservoir 510 full of an adequate supply of water 520 and/or ice 530. Likewise, the carbonator 600 includes all of the components required to provide carbonated water 970 within a single integrated module as opposed to the several components usually required. The use of the carbonator 600 thus provides a significant size reduction as well as associated cost reductions. The beverage dispenser 100 may be portable and may be available for use on a conventional countertop, tabletop, and the like. Moreover, the carbonator 600 may quickly cool down to the appropriate temperature and maintain that temperature during typical use. The flow of carbonated water 970 also may be used to sanitize the cartridges, the coils, the lines, and the like.

FIG. 5 through FIG. 11 shows an example of a potable water/ice slurry refrigeration system 1100 as may be described herein. The potable water/ice slurry refrigeration system 1100 may include an ice bin 1110 separated from a slurry tank 1120 by a grate 1130. The ice bin 1110 may have two ledges 1140 that the grate 1130 may rest thereon. Other types of support structures may be used herein. The grate 1130 may be manufactured from stainless steel, plastics, or other types of food safe materials. The grate 1130 may have spacings 1150 that retain ice cubes 1160 over a specific size. For example, the grate 1130 may have spacings 1150 that will allow ⅜ inch (9.525 millimeter) ice cubes to pass through, but not ½ inch (12.7 millimeter) ice cubes. In addition, the grate spacings 1150 may be uniform or may vary. For instance, certain areas of the grate 1130 may allow ice cubes of ⅜ inch in size to pass through, but not ½ inch in size. Other areas of the grate 1130 may allow ice cubes of ½ inch in size to pass through, but not ⅝ inch (15.875 millimeters) in size. The varying grate spacings 1150 may allow for a more heterogeneous mixture in the slurry tank 1120.

The slurry tank 1120 includes a water/ice slurry 1170 therein. The water/ice slurry 1170 may cool a flow of the macro-ingredients such as a concentrate or a sweetener or other types of ingredients. Specifically, the macro-ingredients may pass through a micro-channel heat exchanger 1180. The micro-channel heat exchanger 1180 may be braised to the undersurface of the slurry tank 1120 or may be otherwise attached or positioned. The micro-channel heat exchangers 1180 may be sized accordingly to the planned operating capacity of the overall dispenser. For example, dispensers with an expected high throughput may be larger to allow for greater cooling capacity. Dispensers with an expected low throughput may have smaller micro-channel heat exchangers 1180 that may achieve the desired cooling while the ingredients are resting within the micro-channel heat exchanger 1180 between dispensing. The micro-channel heat exchangers 1180 described herein may be constructed in a variety of fashions. For example, the micro-channel heat exchanger 1180 may be extruded. The micro-channel heat exchangers 1180 also may be manufactured via a stacked plate construction method. Other types of manufacturing techniques may be used herein.

During operation, a flow of water 1190 may enter the slurry tank 1120 via a water inlet 1200. This water 1190 may mix with the ice 1160 passing through the grate 1130 to form the water/ice slurry 1170. As the chilled water 1190 is need, the water 1190 may exit the slurry tank 1120 via a water outlet 1210 and head to a carbonator or a dispensing nozzle. The slurry tank 1120 may include a low level sensor 1220 that controls the flow of water 1190 into the slurry tank 1120. In addition, the slurry tank 1120 may include an agitator that may be used to break up ice bridges that may form as the ice melts. A sanitizer 1230, UV or filtration, may be connected to the slurry tank 1120 and allow the water 1190 to be sanitized. Other types of sanitation techniques may be used herein. An overflow line 1240 also may be used herein. Other components and other configurations may be used herein.

FIG. 6 and FIG. 7 show a grate 1250 that may be formed of a series of tubing 1260. The tubing 1260 may allow the grate 1250 to act as a pre-chiller for the water 1190. For example, instead of the water 1290 flowing directly into the slurry tank 1020, the water 1190 may first flow through the tubing 1260 of the grate 1250 for chilling. This pre-chilling also may allow heat to flow from the water 1190 to the ice to break up the ice bridges that may form as the ice melts. Furthermore, instead of the tubing 1260, the micro-channel heat exchangers 1180 also may be used to form the grate 1250. Other components and other configurations may be used herein.

The grate 1250 may be connected to the incoming water inlet 1200 via a quick disconnect fitting 1270. The quick disconnect fitting 1270 may act as a valve to stop the flow of water 1190 when the grate 1250 is disconnected. Also, an external shut off valve (not shown) also may be used. As shown in FIG. 7, the grate 1250 may be removable to allow a user greater access to the slurry tank 1120 for cleaning. In addition to pre-chilling the incoming water 1190, the grate 1250 also may include sections that allow for the ingredients to flow therethrough for pre-chilling. Furthermore, instead of one grate 1250 divided into sections, multiple grates 1250 may be used. The multiple grates 1250 may be positioned in the same plane or the grates 1250 may be layered. For instance, as shown in FIG. 8, the inlet water 1190 may pass through a bottom grate 1280 and the ingredients may pass thought an upper grate 1290. Each of the grates may have differently sized spacings 1150 to allow progressively smaller sized ice cubes to reach the water/ice slurry 1170. Other components and other configurations also may be used herein.

FIG. 9 shows the slurry tank 1120 with the micro-channel heat exchanger 1180 positioned within the water/ice slurry 1170. In this example, a pump 1300 used to sanitize the water 1190 also may act as a recirculation pump that may allow the water 1190 to cool the micro-channel heat exchanger 1180 via forced convection. As above, the grate(s) may be used as pre-chillers and/or the grates may be removable for easy cleaning.

FIG. 10 shows the slurry tank 1120 with a first micro-channel heat exchanger 1310 attached thereto. The ingredients may flow through the first micro-channel heat exchanger 1310 to be cooled prior to delivery to a nozzle. In addition, a second micro-channel heat exchanger 1320 may be connected to the first micro-channel heat exchanger 1310. In other words, the first micro-channel heat exchanger 1310 may be sandwiched between the slurry tank 1020 and the second micro-channel heat exchanger 1320. Cooled water 1190 may flow through the second micro-channel heat exchanger 1320 to provide extra cooling capacity to chill the ingredients flowing therethrough. The second micro-channel heat exchanger 1320 may be arranged in parallel or in cross flow to the first micro-channel heat exchanger 1310. Other components and other configurations also may be used herein.

FIG. 11 shows an example of a grate 1330 that may be used as a pre-chiller. The grate 1330 may include an inlet 1340 connected to an inlet manifold 1350. The inlet manifold 1350 may disperse the fluid to various tubing 1260 that may deliver the fluid to an outlet manifold 1360. From the outlet manifold 1360, the fluid may flow to an outlet 1370. The grate 1330 may have any size, shape, or configuration. Other components and other configurations also may be used herein.

It should be apparent that the foregoing relates only to certain embodiments of the present application and the resultant patent. Numerous changes and modifications may be made herein by one of ordinary skill in the art without departing from the general spirit and scope of the invention as defined by the following claims and the equivalents thereof.

We claim:

1. A beverage dispenser for mixing a flow of concentrate, a flow of water, and a flow of gas, comprising:
a carbonator;
the carbonator comprising a water input in communication with the flow of water, a gas input in communication with the flow of gas, a carbonated water output, and a chilling reservoir in communication with the flow of water; and
a dispensing nozzle in communication with the flow of concentrate and a flow of carbonated water from the carbonated water output of the carbonator.

2. The beverage dispenser of claim 1, further comprising a housing and wherein the flow of concentrate, the flow of water, the flow of gas, the carbonator, and the dispensing nozzle are positioned within the housing.

3. The beverage dispenser of claim 1, further comprising a plurality of concentrate cartridges with the flow of concentrate therein.

4. The beverage dispenser of claim 1, further comprising a water/ice reservoir with the flow of water therein.

5. The beverage dispenser of claim 1, further comprising a carbon dioxide tank with the flow of gas therein.

6. The beverage dispenser of claim 1, wherein the carbonator comprises an outer jacket, a water jacket, and with the chilling reservoir therebetween.

7. The beverage dispenser of claim 1, wherein the source of water and the chilling reservoir are in communication via a recirculation loop.

8. The beverage dispenser of claim 1, wherein the carbonator comprises a heat sink.

9. The beverage dispenser of claim 1, wherein the carbonator comprises a thermo-electric chilling device.

10. The beverage dispenser of claim 1, wherein the carbonator is enclosed by a cap.

11. The beverage dispenser of claim 1, wherein the carbonator comprises a plurality of concentrate coils in communication with the flow of concentrate and the dispensing nozzle.

12. The beverage dispenser of claim 1, wherein the carbonator comprises a carbon dioxide solenoid in communication with the flow of gas and wherein the carbon dioxide solenoid is in communication with a carbon dioxide stinger tube.

13. The beverage dispenser of claim 1, wherein the carbonator comprises an agitation bypass solenoid and wherein the agitation by pass solenoid is in communication with a bypass dip tube for recirculating the flow of water.

14. The beverage dispenser of claim 1, wherein the carbonator comprises a carbonated water solenoid in communication with the carbonated water output and wherein the carbonated water solenoid is in communication with a water dip tube.

15. A method of operating a beverage dispenser, comprising:
filling a water/ice reservoir with water and ice;
circulating a first flow of water about a carbonator to chill the carbonator;
flowing a second flow of water into the carbonator;
flowing a flow of gas into the carbonator to produce a flow of carbonated water;
flowing the flow of carbonated water to a dispensing nozzle; and
flowing a flow of concentrate through a concentrate coil in the carbonator and to the dispensing nozzle.

16. A carbonator for use with a beverage dispenser for mixing a flow of concentrate, a flow of water, and a flow of gas, comprising:
a water input in communication with the flow of water;
a gas input in communication with the flow of gas;
a carbonated water output;
a chilling reservoir in communication with the flow of water; and
a concentrate coil in communication with the flow of concentrate.

17. The carbonator of claim 16, further comprising an outer jacket, a water jacket, and with the cooling reservoir therebetween.

18. The carbonator of claim 16, further comprising a heat sink and/or a thermo-electric chilling device.

19. The carbonator of claim 16, further comprising a carbon dioxide solenoid in communication with the flow of gas and wherein the carbon dioxide solenoid is in communication with a carbon dioxide stinger tube.

20. The carbonator of claim 16, further comprising a carbonated water solenoid in communication with the carbonated water output and wherein the carbonated water solenoid is in communication with a water dip tube.

21. A potable water/ice slurry refrigeration system, comprising:
a water/ice slurry tank;
a heat exchanger positioned about the water/ice slurry tank;
an ice bin positioned about the water/ice slurry tank; and
a grate positioned between the water/ice slurry tank and the ice bin.

22. The potable water/ice slurry refrigeration system of claim 21, wherein the grate comprising a plurality of spacings therein.

23. The potable water/ice slurry refrigeration system of claim 22, wherein the plurality of spacings comprises a plurality of variable spacings.

24. The potable water/ice slurry refrigeration system of claim 21, wherein the heat exchanger comprises a micro-channel heat exchanger.

25. The potable water/ice slurry refrigeration system of claim 21, wherein the water/ice slurry tank comprises a sanitizer in communication therewith.

26. The potable water/ice slurry refrigeration system of claim 21, wherein the grate comprises a plurality of tubing.

27. The potable water/ice slurry refrigeration system of claim 21, wherein the grate comprises a quick disconnect fitting.

28. The potable water/ice slurry refrigeration system of claim 21, further comprising a plurality of grates.

29. The potable water/ice slurry refrigeration system of claim 21, wherein the water/ice slurry tank comprises a recirculation pump in communication therewith.

30. The potable water/ice slurry refrigeration system of claim 21, further comprising a plurality of heat exchangers.

31. A method of chilling fluids in a beverage dispenser, comprising:
positioning an amount of ice in an ice bin;
allowing the ice to melt into a water/ice slurry tank;
flowing water into the water/ice slurry tank;
flowing an ingredient through a heat exchanger positioned about the water/ice slurry tank;
flowing water from the water/ice slurry tank to a nozzle; and
flowing the ingredient from the heat exchanger to the nozzle.
